(19) United States
(12) Patent Application Publication
(10) Pub. No.: US 2009/0105087 A1
(43) Pub. Date: Apr. 23, 2009

(54) MICROELECTRONIC DEVICE WITH CONTROLLABLE REFERENCE SUBSTANCE SUPPLY

(75) Inventors: Josephus Arnoldus Henricus Maria Kahlman, Tilburg (NL); Menno Willem Jose Prins, Rosmalen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/282,713

(22) PCT Filed: Mar. 5, 2007
(86) PCT No.: PCT/IB2007/050710

§ 371 Date: Sep. 12, 2008

(30) Foreign Application Priority Data
Mar. 15, 2006 (EP) 06111190.2

(51) Int. Cl. C40B 30/04; C40B 60/12

(52) U.S. Cl. 506/9; 506/39

(57) ABSTRACT

The invention relates to microelectronic device (100) and a method that allow the controlled release of a reference substance (21, 22, 23) into the sample chamber (5) of a biosensor. In a particular embodiment, this is achieved by a supply unit (20) comprising a control wire (24) that can generate a magnetic field in a storage region of the sample chamber (5). Magnetic reference particles (22) can then enclose and retain reference target molecules (21) until the magnetic field is reduced or switched off, releasing the target molecules at a desired point in time. The controlled release of a reference substance (21, 22, 23) may for instance be used for the calibration of a magnetic biosensor.

The invention relates a microelectronic device and a method for manipulating assay substances in a sample chamber.

An important example of such a microelectronic device are biosensors that may be used for detecting target molecules in blood, saliva and other human or animal body fluids or tissues, or molecules in environmental samples or food samples. From the WO 2005/010543 A1 and WO 2005/010542 A2 a microsensor device is known which may for example be used in a microfluidic biosensor for the detection of biological molecules labeled with magnetic beads. The microsensor device is provided with an array of sensors comprising wires for the generation of a magnetic field and Giant Magneto Resistances (GMRs) for the detection of stray fields generated by magnetized beads.

One of the important challenges with the aforementioned biosensors is the manipulation and control of assay substances, e.g. assay reagents for the quantitative calibration of the assay. The response of the biosensor can have variations due to several process parameters in the assay, e.g. the biochemical affinity constants kₒₙ and k_{off} of the binding between target molecules and capture molecules, diffusion parameters, the biological activity of molecules and coatings of beads and sensor chip, or the magnetic properties of the beads. Said parameters may vary for instance as a function of temperature, ageing and production variations. A state-of-the-art approach is to calibrate the response of a reference liquid against a reference curve by applying a known concentration of target molecules to a separate sensor than the sensor where the sample is applied. For example, in a well-plate a few wells may be used for calibration and other wells may be used with unknown samples. In an integrated device, this method requires a multi chamber system with several sensors, which is complex and expensive.

Apart from the aforementioned calibration issues, a controlled release of reagents is important in bio-sensing, e.g. in sandwich, competition or inhibition immunoassays, anti-complex assays, selective blocking agent assays, or nucleic acid assays. In well-plates, reagents are generally dispensed with robotic equipment. In lateral-flow assays, reagents are often added to a sample by dissolution of a sugar-like matrix in the test strip.

Based on this situation it was an object of the present invention to provide means for an improved and more accurate manipulation, especially measurement of assay substances in a microelectronic device.

This objective is achieved by a microelectronic device according to claim 1 and a method according to claim 11. Preferred embodiments are disclosed in the dependent claims.

The microelectronic device according to the present invention is intended for the manipulation of an assay substance. Here and in the following the term “substance” shall refer to any kind of material including materials that are composed of several components. In a typical case, the “assay substance” can comprise a sample or target component (e.g. a liquid or gaseous chemical substance like a biological body fluid) and all substances that get into contact with the sample or a part thereof (e.g. buffer salts, proteins, biological capture molecules on a sensor surface, magnetic particle labels, reference materials etc.). The term “manipulation” shall denote any interaction with the assay substance, for example measuring characteristic quantities, investigating its properties, processing it mechanically or chemically or the like. The microelectronic device comprises the following components:
a) A sample chamber in which the assay substance can be provided. The sample chamber is typically an empty cavity or a cavity filled with some material that can be displaced or that can absorb the assay substance (e.g. a gel or a porous material).
b) A supply unit for releasing a reference substance from a storage into the sample chamber in a controlled way.

By the incorporation of a supply unit that allows to release a reference substance in a definite, known way into the sample chamber, the functionality of the microelectronic device can be substantially extended. Particular important examples of additional functions will be described in the following with respect to different embodiments of the invention.

The storage where the reference substance is kept may preferably be located inside the sample chamber. This guarantees that the reference substance quickly distributes in the sample chamber after its release. Furthermore it avoids the need for micro-fluidic measures to transport the reference substance into the sample chamber.

There are different possible ways to realize a supply unit with the required capability of a controlled release of a substance from a storage. In a particular realization, the supply unit comprises a field generator for generating an electrical or preferably a magnetic field in the storage. The field generator may for instance be an electrode that is integrated into the substrate of the microelectronic device. By connecting said electrode to an electrical potential or by letting a current flow through the electrode, an electrical field or a magnetic field can readily be generated in a precisely controllable way.

According to another embodiment of the invention, the storage is covered by a material like a membrane or a sheet that can be disrupted or removed by exerting an expelling force on a reference substance in the storage. The expelling force may for example be generated by electrical or magnetic fields or by heating the storage.

In still another embodiment, the microelectronic device comprises at least one guide electrode for generating magnetic or electrical fields that can lead magnetically or electrically interactive particles from the storage to a target location in the sample chamber. In this way the movement of such particles to a target location can be considerably accelerated compared to a usual diffusion-controlled spreading.

Preferably the aforementioned device comprises several such guide electrodes and a controller coupled to them for activating the electrodes in sequence. Thus the particles can gradually be transported from the storage to the target location.

While in general the storage of the supply unit may be empty or filled, it is preferred that the storage is furnished with a suitable reference substance. Such a microelectronic device will then leave the factory ready for an immediate use, e.g. as a roadside drug test device.

As was already mentioned, the manipulation of the assay substance can take many different forms. In a preferred embodiment, the microelectronic device includes a sensor unit for measuring characteristic (optical, magnetic, electrical, chemical etc.) features of the assay substance or a component thereof. Said sensor unit optionally comprises a magnetic field generator for generating a magnetic field in the sample chamber (or at least a sub-region thereof) and a magnetic sensor element for sensing magnetic (stray) fields originating in the sample chamber. The magnetic sensor element may particularly be a magneto-resistive element, for example a GMR (Giant Magneto Resistance), TMR (Tunnel Magneto Resistance) or AMR (Anisotropic Magneto Resistance), or comprise Hall elements.

The sample chamber of the microelectronic device may optionally comprise an inlet for providing it with the assay substance or a component thereof. Thus it is for example possible to reuse the device for the measurement of many samples or to perform complex assays that comprise the application of several reagents in sequence.

The invention further relates to a method for manipulating an assay substance in a sample chamber, the method comprising the controlled release of a known amount of a reference substance from a storage into the sample chamber. Such a controlled release of a known amount of some substance offers new possibilities in various applications, which will be described in more detail with reference to preferred embodiments of the method.

The method may further comprise the measurement of at least one characteristic feature of the assay substance by a sensor unit. The sensor unit may for example be an optical sensor that can detect optical label substances like fluorescent molecules.

In a preferred embodiment, the aforementioned measurement is based on magnetically or electrically interactive labeling particles that can bind to or are bound to a target component of the assay substance. A measurement of magnetically interactive labeling particles is for example the basis of magnetic biosensors that were already mentioned above.

The method may particularly comprise an error check and/or a calibration of the mentioned sensor unit based on the controlled release of the reference substance.

If for example the reference substance should normally provoke a signal of the sensor unit, and if such a signal does not appear after the release of the reference substance, this is a clear indication of a malfunction of the microelectronic device. In a more elaborate evaluation of the controlled release of the reference substance, the latter may be used for the calibration of the sensor unit as the observed signal of the sensor unit is (at least partially) generated by known conditions in the sample chamber.

In another embodiment of the method, the release of the reference substance takes place a predetermined time after the assay substance or a component thereof has been introduced into the sample chamber. Thus there is some time during which the pure effect of the assay substance can be measured; after this time, the introduction of the reference substance creates definite conditions that can be used to verify and calibrate the previous measurements.

In the following, preferred embodiments of the invention will be explained that refer both to the microelectronic device and the method described above.

According to a first preferred embodiment of this kind, the surface of the sample chamber comprises binding sites for immobilizing a target component of the assay substance. The region above the sensor unit may for example be coated with certain antibodies to which target molecules can bind.

In the aforementioned case, the reference substance preferably comprises a reference target component that can bind to the binding sites. Thus the binding process of the assay substance can be modeled by the reference target component. In the most simple case, the reference target component may be of the same kind as a target component of the assay substance.

In another preferred embodiment, the reference substance comprises magnetically or electrically interactive reference particles which can be retained in the storage with magnetic or electrical fields. Said particles may particularly be mixed with a reference target component or enclose a reference target component the release of which is of primary interest in the underlying application.

In the aforementioned embodiment, the strength of the magnetic or electrical fields may gradually be reduced during the release of the reference substance. This allows to extend the release process over a certain time interval. Moreover, a gradual reduction of the field strength allows to release weakly attracted particles first and thus a differentiated release of reference substances.

In a further development of the aforementioned embodiments, the reference substance comprises a reference target component, and the reference particles are attracted or can be attracted to said reference target component. The attraction stabilizes the retention of the reference target component in the storage. The reference target component may particularly be the same material as a target component of the assay substance and the reference particles may particularly be the same material as the labeling particles described above.

If the reference substance comprises a reference target component which is of primary interest for the underlying application, this can particularly be embedded into a carrier. Said carrier may for example be a dissolvable matrix, a sugar or a similar material.

The invention further relates to the use of the microelectronic device described above for molecular diagnostics, biological sample analysis, or chemical sample analysis. Molecular diagnostics may for example be accomplished with the help of magnetic beads that are directly or indirectly attached to target molecules.

These and other aspects of the invention will be apparent from and elucidated with reference to the embodiment(s) described hereinafter. These embodiments will be described by way of example with the help of the accompanying drawings in which:

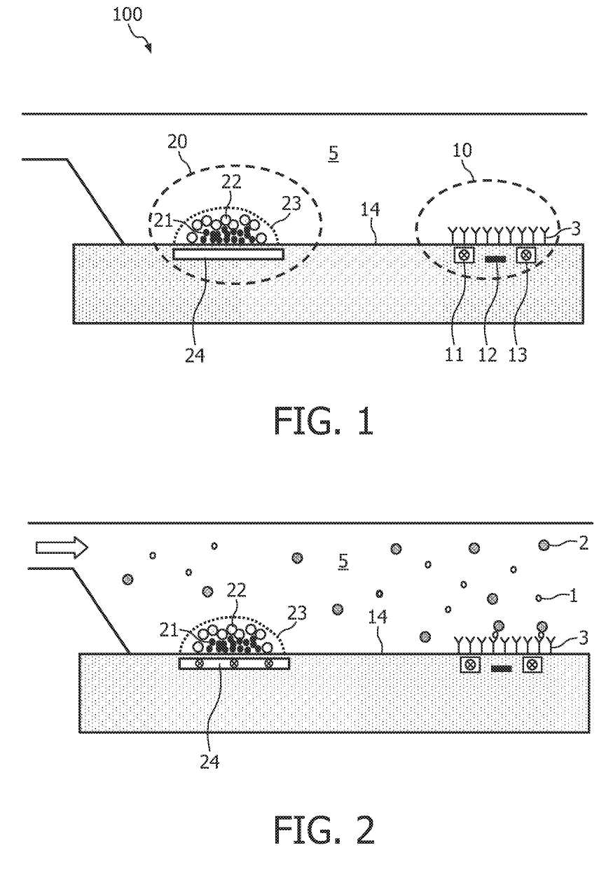

FIG. 1 shows schematically a cross section through a magnetic biosensor according to a preferred embodiment of the invention before a measurement takes place;

FIG. 2 shows the biosensor of FIG. 1 after the introduction of an assay substance into the sample chamber;

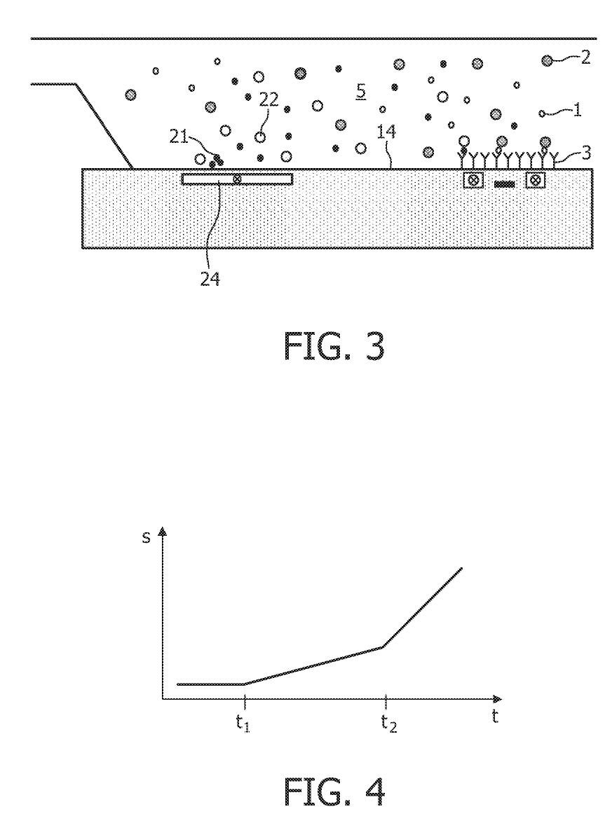

FIG. 3 shows the microelectronic sensor of FIG. 2 after the release of the reference substance from the storage of the supply unit;

FIG. 4 shows schematically the sensor signal observed during the process described in FIGS. 1-3;

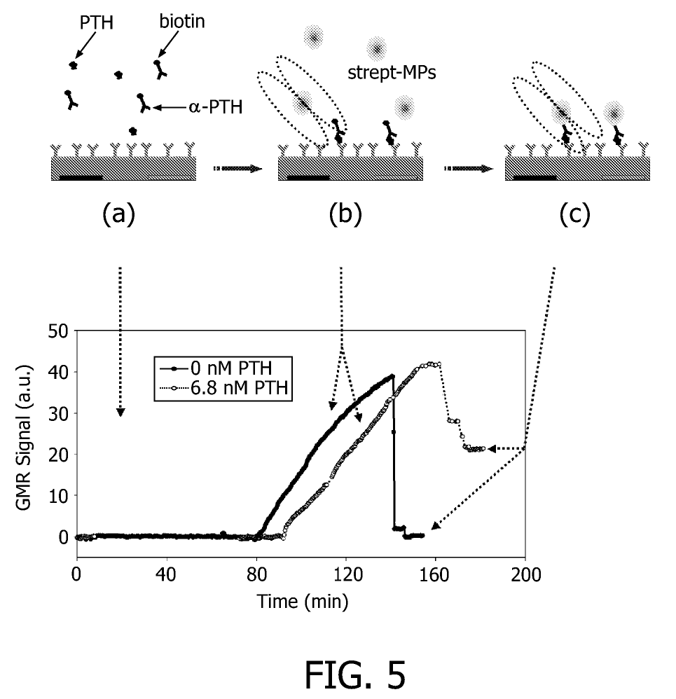

FIG. 5 shows schematically the application of the present invention in connection with an immunoassay.

Like reference numbers in the Figures refer to identical or similar components.

Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

FIG. 1 shows schematically a part of a magnetic biosensor 100 according to the present invention in a cross sectional view. In the right part of the Figure, the sensor unit 10 is depicted. It comprises two conductor wires 11, 13 for generating a magnetic field in the adjacent region of a sample chamber 5. Between said wires 11 and 13, a Giant Magneto Resistance (GMR) element 12 is located that can measure magnetic (stray) fields originating in the sample chamber 5. The wires 11, 12 and 13 are realized in or on a suitable substrate. The surface 14 of said substrate, which faces the sample chamber 5, is at least partially coated with binding molecules 3 which can specifically bind to target molecules 1 (FIG. 2). Although the microelectronic device is described in connection with a GMR, the sensor unit 10 can be any suitable sensor unit 10 to detect the presence of magnetic particles on or near to a sensor surface, based on any property of the particles, e.g. it can detect via magnetic methods, e.g. magnetoresistive, Hall, coils. The sensor unit 10 can also detect via optical methods, for example imaging, fluorescence, chemiluminescence, absorption, scattering, surface plasmon resonance, Raman spectroscopy etc. Further, the sensor unit 10 can detect via sonic detection, for example surface acoustic wave, bulk acoustic wave, cantilever deflections influenced by the biochemical binding process, quartz crystal etc. Further, the sensor unit 10 can detect via electrical detection, for example conduction, impedance, amperometric, redox cycling, etc. Moreover, combinations of more than one detection method described above are applicable.

FIG. 1 further shows a supply unit 20 which is located on the same substrate but a distance apart from the sensor unit 10. The supply unit primarily comprises a control wire 24 running underneath the surface 14 of the substrate. When a current is led through said control wire 24, a magnetic field is generated in the adjacent region of the sample chamber 5. Said region serves as the “storage” of the supply unit 10.

The storage of the supply unit 20 is furnished with a reference substance that comprises in the shown example three components: (i) reference target molecules 21, (ii) reference magnetic beads 22 which enclose the reference target molecules 21, and (iii) a sugar-like material 23 which embeds both the reference beads 22 and the reference target molecules 21. The reference beads 22 may be equipped with or without antibodies for binding to the reference target molecules 21.

FIG. 1 shows the ready-to-use state of the biosensor 100 after leaving fabrication, i.e. the sample chamber 5 is still empty (or, more precisely, only filled with air). The biosensor 100 may be calibrated in this state, for example by measuring the internal magnetic crosstalk between the wires 11, 13 and 12 in absence of magnetic particles on the sensor surface 14. The corresponding signal is well defined by the geometry of the sensor wires.

FIG. 2 shows the second phase of a measurement with the biosensor 100, during which a current is applied to the wire 24 under the supply unit 20 such that the reference beads 22 remain attracted on the chip surface 14 by magnetic forces. Then a liquid sample substance, which comprises target molecules 1 and magnetic labeling beads 2, is fed into the sample chamber 5 above the chip. The binding of target molecules 1 and labeling beads 2 onto the binding molecules 3 of the sensor starts.

Some of the reagents in the supply unit 20 may dissolve into the sample fluid (e.g. a sugar coating at the periphery), but the reference target molecules 21 are kept on place by the reference beads 22, which are magnetically attracted to the chip surface 14.

It should be noted that the in the general case, the microelectronic device is intended for manipulating an “assay substance” which optionally comprises the following components:

1. target component/molecules 1,

2. labeling beads/particles 2;

3. supplemental components (comprising all materials that get into contact with the target component, e.g. buffer salts, proteins, biological capture molecules 3 on the sensor surface, components 21, 22, 23 of the reference substance etc.).

Similarly, the term “reference substance” in general comprises the following optional components:

1. reference target component/molecules 21,

2. reference beads/particles 22;

3. supplemental reference components, e.g. a sugar matrix 23.

FIG. 3 shows the next phase of a measurement with the biosensor 100, during which the current in the wire 24 under the supply unit 20 is altered, e.g. reduced or switched off. Consequently, the “magnetic blanket” weakens and the reference target molecules 21 can disperse into the fluid. The reference target molecules 21 can then cause reference beads 22 to bind to the sensor surface 14. In this way the target concentration has increased by a known amount of reference target molecules 21 after a certain delay time, which changes the sensor response accordingly. In a typical embodiment, the reference target molecules 21 may be of the same kind as the target molecules 1 and/or the reference magnetic beads 22 may be of the same kind as the magnetic labeling beads 2.

FIG. 4 sketches the sensor response during the described measurement. At t<t₁, the sensor signal s represents the magnetic crosstalk. This signal may be used to calibrate the detection gain including the GMR sensor gain. When at t=t₁, the assay is started (corresponding to the transition from FIG. 1 to FIG. 2), and the sensor signal s increases according to a slope indicative to the concentration of target molecules 1 in the test liquid. At t=t₂, the reference target molecules 21 are released (corresponding to the transition from FIG. 2 to FIG. 3), which increases the concentration of targets in a well-defined way. As a result the kinetics of the assay will speed-up due to the higher concentration of target molecules. This effect may be used to calibrate the total biosensor response, including the biological binding constants involved in the sandwich bead-target-surface.

If the kinetics of the assay does not change after releasing the reference target molecules 21, the obvious conclusion must be that the magnetic biosensor does not function correctly and the result of the assay is rejected. This is a method to detect e.g. false-positive or false-negative results.

When the current through the current wire 24 is reduced in FIG. 3, first the beads 21 with lowest attraction force will escape, i.e. particles with the lowest magnetic moment. Larger particles or clusters of particles will remain in the storage area. This is a kind of a selection method, which can be used to effectively get single beads on the sensor surface and suppress signals by clusters of beads or other large magnetic particles. This will improve the reliability and quantitative accuracy of the detection.

It should be noted that the reference beads 22 should not interfere with the detection process on the sensor. Preferably, the labeling beads 2 are present at a much higher concentration than the reference beads 22. Alternatively, the reference beads 22 may be of a different type such that they can selectively be kept away from the sensor (e.g. by magnetic forces) or can be separated in the detection signal (e.g. due to a different size or magnetic relaxation time).

In an optional modification of the described embodiment, the reference beads 22 are bonded to the reference target molecules 21 in the supply unit 20. This better mechanically stabilizes the target molecules 21 in the supply unit 20 when starting the assay, but it discards the target-bead affinity constants from the calibration.

In another optional modification, no sugar coating 23 but a membrane (e.g. a thin polymer layer) keeps the reference targets 21 and reference beads 22 together. The membrane can be destroyed by magnetically lift-off the beads 22 from the surface 14 by generating magnetic forces. Said forces may be generated by e.g. an external magnetic field and a field gradient induced by integrated current wires 24.

As described above, a supply unit 20 may be used in a biosensor for calibration purposes. It may however also for other reasons be advantageous to release magnetic beads into a reaction chamber after a certain time. One example is a sequential assay, in which first target molecules and/or other biochemical components bind to the sensor surface, and only thereafter the magnetic beads are released into the solution to bind to the molecules on the sensor surface. FIG. 5 sketches an Immunoassay as an example of such a sequential assay. In this assay the first processes occur with molecules free from magnetic beads (cf. FIG. 5(a): addition of PTH and biotinylated α-PTH). Thereafter biotinylated α-PTH is removed from the chamber (e.g. by a washing step), magnetic beads are released into the chamber, and these proceed to the sensor surface. This may speed up the reaction processes and/or make the process more reliable, as the beads can show rather slow diffusion and give steric hindrance during the first binding process. Another advantage is that the binding of beads to the molecules on the sensor surface can occur via a strong binding couple such as streptavidin-biotin. FIG. 5(b) shows the sedimentation and binding of streptavidin-coated magnetic beads, and FIG. 5(c) shows how only bound magnetic beads remain after washing. The diagram of FIG. 5 shows the corresponding signals measured with a GMR sensor (arbitrary units).

A supply unit can also be used to supply an additional type of magnetic particles into the chamber after a well-defined time. Such particles can for example be magnetic particles that are suited to apply magnetic stringency.

One possibility to achieve a delayed release of magnetic beads or other particles is to embed the particles in a dissolvable matrix (e.g. a sugar material). When the chip is wetted, the matrix dissolves and the particles are free to move. Though magnetic beads show thermal motions, they can be kept in the vicinity of a wire through which a current is led due to magnetic attraction toward the wire. When the current is decreased or removed, the magnetic beads can move away from the wire toward the sensor surface.

Once magnetic particles are released from the storage of a supply unit, it may be advantageous to keep them rather close to the chip surface and laterally guide them along the chip surface toward a sensor unit. This will avoid that particles get lost into the bulk of the sample chamber or take a long time to reach the sensor surface. The guiding can be done using neighboring current wires that are alternatingly actuated (not shown).

In summary, the generic idea of the present invention is to use a timed release of (bio)chemical reagents by applying magnetic particles and magnetic fields. Such a timed release of reagents can be used to calibrate a sensor by adding a known concentration of reference target molecules, which are released into the fluidic chamber of the biosensor by valving with magnetic particles. The timed release of reagents can also be applied to supply magnetic particles to the sensor surface at a desired time in the assay.

Many modifications and further developments of the embodiments described above can be made:
Reagents can for example be deposited onto the chip by ink-jet printing or needle dispensing.
Instead of a magnetic sensor unit, also an optical sensor and optical (e.g. fluorescent) labels can be used.
Dispersion of reagents into the fluid can be done by passive forces (e.g. diffusion) or actively (magnetic forces, acoustic excitation, electric fields etc.).

The above principles can be applied to various types of assay, for example also to a drugs-of-abuse inhibition or competition assay in saliva.

Advantages of the present invention are that no extra micro fluidic measures are necessary on the described biosensor and that a total assay calibration is possible.

Finally it is pointed out that in the present application the term “comprising” does not exclude other elements or steps, that “a” or “an” does not exclude a plurality, that a “substance” may relate to any kind of material (particularly pure chemical elements as well as mixtures), and that a single processor or other unit may fulfill the functions of several means. The invention resides in each and every novel characteristic feature and each and every combination of characteristic features. Moreover, reference signs in the claims shall not be construed as limiting their scope.

1. Microelectronic device (100) for manipulating an assay substance (1, 2, 3, 21, 22, 23), comprising:
a) a sample chamber (5) in which the assay substance (1, 2, 3, 21, 22, 23) can be provided;
b) a supply unit (20) for releasing a reference substance (21, 22, 23) from a storage into the sample chamber (5) in a controlled way.

2. The microelectronic device (100) according to claim 1,
characterized in that the storage is located in the sample chamber (5).

3. The microelectronic device (100) according to claim 1,
characterized in that the supply unit (20) comprises a field generator, particularly an electrode (24) integrated into the substrate of the microelectronic device (100), for generating a magnetic and/or electrical field in the storage.

4. The microelectronic device (100) according to claim 1,
characterized in that the storage is covered by a material, prey a membrane or a sheet, that can be disrupted or removed by exerting an expelling force on a reference substance (21, 22, 23) in the storage.

5. The microelectronic device (100) according to claim 1,
characterized in that it comprises at least one guide electrode for generating a magnetic or electrical field that can lead magnetically or electrically interactive particles from the storage to a target location in the sample chamber (5).

6. The microelectronic device (100) according to claim 5,
characterized in that it comprises several such guide electrodes and a controller for activating them in sequence.

7. The microelectronic device (100) according to claim 1,
characterized in that the storage of the supply unit (20) is furnished with a reference substance (21, 22, 23).

8. The microelectronic device (100) according to claim 1,
characterized in that it comprises a sensor unit (10) for measuring characteristic features of the assay substance (1, 2, 3, 21, 22, 23).

9. The microelectronic device (100) according to claim 8,
characterized in that the sensor unit (10) comprises a magnetic field generator (11, 13) for generating a magnetic field in the sample chamber (5) and a magnetic sensor element (12).

10. The microelectronic device (100) according to claim 1,
characterized in that the sample chamber (5) has an inlet for providing it with the assay substance or a component (1, 2) thereof.

11. A method for manipulating an assay substance (1, 2, 3, 21, 22, 23) in a sample chamber (5), comprising the controlled release of a known amount of a reference substance (21, 22, 23) from a storage into the sample chamber (5).

12. The method according to claim 11,
characterized in that it comprises a measurement of a characteristic feature of the assay substance (1, 2, 3, 21, 22, 23) by a sensor unit (10).

13. The method according to claim 12,
characterized in that the assay substance comprises magnetically or electrically interactive labeling particles (2) that can bind to or are bound to a target component (1) of the assay substance.

14. The method according to claim 12,
characterized in that it comprises an error check and/or a calibration of the sensor unit (10) based on the controlled release of the reference substance (21, 22, 23).

15. The method according to claim 11,
characterized in that the release of the reference substance (21, 22, 23) takes place a predetermined time after the assay substance or a component (1, 2) thereof has been introduced into the sample chamber (5).

16. The microelectronic device (100) according to claim 1
characterized in that the surface (14) of the sample chamber (5) comprises binding sites (3) for immobilizing a target component (1, 2, 21, 22) of the assay substance.

17. The microelectronic device (100) or the method according to claim 16, characterized in that the reference substance comprises a reference target component (21) that can be bound by the binding sites.

18. The microelectronic device (100) according to claim 1
characterized in that the reference substance comprises magnetically or electrically interactive reference particles (22) which can be retained in the storage with magnetic or electrical fields.

19. The microelectronic device (100) or the method according to claim 18, characterized in that the strength of the magnetic or electrical fields is gradually changed during the release of the reference substance (21, 22, 23).

20. The microelectronic device (100) or the method according to claim 18, characterized in that the reference substance comprises a reference target component (21) and that the reference particles (22) are bound to or can be bound to the reference target component.

21. The microelectronic device (100) according to claim 1
characterized in that the reference substance comprises a reference target component (21) embedded in a carrier, particularly a dissolvable matrix or a sugar.

22. Use of the microelectronic device (100) according to claim 1 for molecular diagnostics, biological sample analysis, or chemical sample analysis.
